(19) United States
(12) Patent Application Publication
(10) Pub. No.: US 2010/0314788 A1
(43) Pub. Date: Dec. 16, 2010

(54) Production of Ultrafine Particles in a Plasma System Having Controlled Pressure Zones

(76) Inventors: Cheng-Hung Hung, Wexford, PA (US); Noel R. Vanier, Wexford, PA (US)

Correspondence Address: PPG INDUSTRIES INC;INTELLECTUAL PROPERTY DEPT, ONE PPG PLACE, PITTSBURGH, PA, 15272, US

(21) Appl. No.: 12/824,994

(22) Filed: Jun. 28, 2010

Related U.S. Application Data
(63) Continuation-in-part of application No. 11/839,607, filed on Aug. 16, 2007, now Pat. No. 7,758,838.
Application No. 11/839,607 is a continuation-in-part of application No. 11/534,346, filed on Sep. 22, 2006.
(60) Provisional application No. 60/822,781, filed on Aug. 18, 2006.

(51) Int. Cl. B29B 9/00

(52) U.S. Cl. 264/5; 425/6

(57) ABSTRACT

A system and method for making ultrafine particles are disclosed. A high temperature plasma is generated at an inlet end of a plasma chamber into which precursor materials are introduced. A converging member is located adjacent an outlet end of the plasma chamber. During operation, a substantially constant pressure and/or material flow pattern is maintained to reduce or eliminate fouling of the system.

### CROSS REFERENCE TO RELATED APPLICATIONS

This application is a continuation-in-part of application Ser. No. 11/839,607 filed Aug. 16, 2007, which claims the benefit of Provisional Application Ser. No. 60/822,781 filed Aug. 18, 2006. This application is also a continuation-in-part of application Ser. No. 11/534,346 filed Sep. 22, 2006. All of these applications are incorporated herein by reference.

### GOVERNMENT CONTRACT

This invention was made with United States government support under Contract Number W15QKN-07-C-0069 awarded by the United States Army. The United States government has certain rights in this invention.

### FIELD OF THE INVENTION

The present invention relates to the production of ultrafine particles in a plasma system having controlled pressure zones.

### BACKGROUND OF THE INVENTION

Ultrafine particles have become desirable for use in many applications. As the average primary particle size of a material decreases to less than 1 micron a variety of confinement effects can occur that can change the properties of the material. For example, a property can be altered when the entity or mechanism responsible for that property is confined within a space smaller than some critical length associated with that entity or mechanism. As a result, ultrafine particles represent an opportunity for designing and developing a wide range of materials for structural, optical, electronic and chemical applications, such as coatings.

Various methods have been employed to make ultrafine particles. Among these are various vapor phase synthesis methods, such as flame pyrolysis, hot walled reactor, chemical vapor synthesis, and rapid quench plasma synthesis, among others. Unfortunately, such processes are often not commercially viable. First, in many cases, the use of solid precursors is not desirable in such processes because they vaporize too slowly for the desired chemical reactions to occur in the time before the vaporized stream cools. As a result, in many cases, if the use of a solid precursor is desired, it must be heated to a gaseous or liquid state before introduction into the vapor phase synthesis process. Second, the equipment utilized in such processes is often susceptible to fouling, which causes disruptions in the production process for cleaning of the equipment.

As a result, it would be desirable to provide a system for producing ultrafine particles that results in a reduction or, in some cases, elimination of system fouling.

### SUMMARY OF THE INVENTION

An aspect of the invention provides a system for making ultrafine particles comprising a plasma chamber having axially spaced inlet and outlet ends, a high temperature plasma positioned adjacent the inlet end of the plasma chamber, at least one precursor inlet for introducing a precursor to the plasma chamber where the precursor is heated by the plasma to produce a gaseous product stream flowing toward the outlet end of the plasma chamber, and a converging member located adjacent the outlet end of the plasma chamber through which the gaseous product stream flows, wherein a substantially constant pressure is maintained in the plasma chamber and the converging member during operation of the apparatus.

Another aspect of the invention provides a system for making ultrafine particles comprising a plasma chamber having axially spaced inlet and outlet ends, a high temperature plasma positioned adjacent the inlet end of the plasma chamber, at least one precursor inlet for introducing a precursor to the plasma chamber where the precursor is heated by the plasma to produce a gaseous product stream flowing toward the outlet end of the plasma chamber, and a converging member located adjacent the outlet end of the plasma chamber through which the gaseous product stream flows, wherein a substantially uniform material flow pattern is maintained in the plasma chamber and the converging member during operation of the apparatus.

A further aspect of the invention provides a method of making ultrafine particles comprising introducing a precursor material into a plasma chamber, heating the precursor material in the plasma chamber with a plasma to produce a gaseous product stream flowing toward an outlet end of the plasma chamber, and passing the gaseous product stream through a converging member located adjacent the outlet end of the plasma chamber, wherein a substantially constant pressure and a substantially uniform material flow pattern are maintained in the plasma chamber and converging member as the gaseous product stream flows through the plasma chamber and converging member.

### BRIEF DESCRIPTION OF THE DRAWINGS

FIG. 1 is a partially schematic side sectional view of a system for producing ultrafine particles in accordance with certain embodiments of the present invention.

FIG. 2 is a cross-sectional view taken through line A-A of FIG. 1.

FIG. 3 is a cross-sectional view similar to that of FIG. 2 illustrating another embodiment of the present invention.

FIG. 4 is a velocity vector profile illustrating a relatively uniform material flow pattern inside a plasma chamber during operation of a plasma system in accordance with an embodiment of the present invention.

FIG. 5 is a pressure profile illustrating a substantially constant pressure inside a plasma chamber during operation of a plasma system in accordance with an embodiment of the present invention.

FIG. 6 is a non-uniform vector velocity profile illustrating a turbulent material flow pattern inside a plasma chamber from a comparative example.

FIG. 7 is a non-uniform pressure profile inside a plasma chamber from a comparative example.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, certain embodiments of the present invention are directed to methods and/or apparatus for making ultrafine particles. As used herein, the term “ultrafine particles” refers to solid particles having a B.E.T. specific surface area of at least 10 square meters per gram, such as 30 to 500 square meters per gram, or, in some cases, 90 to 500 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the ultrafine particles made in accordance with the present invention have a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:

Diameter(nanometers)=6,000/[BET(m²/g)*ρ(grams/cm³)]

In certain embodiments, the ultrafine particles have an average primary particle size of no more than 100 nanometers, in some cases, no more than 50 nanometers or, in yet other cases, no more than 30 nanometers or, in other cases, no more than 10 nanometers. As used herein, the term “primary particle size” refers to a particle size as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

A plasma is a high temperature luminous gas which is at least partially (1 to 100%) ionized. A plasma is made up of gas atoms, gas ions, and electrons. A thermal plasma can be created by passing a gas through an electric arc. The electric arc will rapidly heat the gas by resistive and radiative heating to very high temperatures within microseconds of passing through the arc. The plasma is often luminous at temperatures above 9,000 K.

A plasma can be produced with any of a variety of gases. This can give excellent control over any chemical reactions taking place in the plasma as the gas may be inert, such as argon, helium, or neon, reductive, such as hydrogen, methane, ammonia, and carbon monoxide, or oxidative, such as oxygen, nitrogen, and carbon dioxide. Air, oxygen, and/or oxygen/argon gas mixtures are often used to produce ultrafine particles in accordance with the present invention.

Certain embodiments of the present invention are directed to methods for making ultrafine particles in a plasma system in which a precursor is introduced into a feed chamber. As used herein, the term “precursor” refers to a substance from which a desired product is formed. The precursor may comprise virtually any material, depending upon the desired composition of the ultrafine particles. The precursor may be introduced as a solid, liquid, gas, or a mixture thereof. In certain embodiments, the precursor is introduced as a liquid. In certain embodiments, the liquid precursor comprises an organometallic material, such as, for example, cerium-2 ethylhexanoate, zinc phosphate silicate, zinc-2 ethylhexanoate, calcium methoxide, triethylphosphate, lithium 2,4 pentanedionate, yttrium butoxide, molybdenum oxide bis(2,4-pentanedionate), trimethoxyboroxine, aluminum sec-butoxide, trimethylborate, among other materials, including mixtures thereof. In certain embodiments, such as when ultrafine silica particles are desired, the organometallic comprises an organosilane. Suitable organosilanes include those comprising two, three, four, or more alkoxy groups. Specific examples of suitable organosilanes include methyltrimethoxysilane, methyltriethoxysilane, methyltrimethoxysilane, methyltriacetoxysilane, methyltripropoxysilane, methyltributoxysilane, ethyltrimethoxysilane, ethyltriethoxysilane, γ-meth-acryloxypropyltrimethoxysilane, γ-aminopropyltri-methoxysilane, γ-aminopropyltriethoxysilane, γ-mercaptopropyltrimethoxysilane, chloromethyltrimethoxysilane, chloromethytriethoxysilane, dimethyldiethoxysilane, γ-chloropropylmethyldimethoxysilane, γ-chloropropyl-methyldiethoxysilane, tetramethoxysilane, tetraethoxysilane, tetra-n-propoxysilane, tetra-n-butoxysilane, glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxy-propyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, γ-glycidoxypropylmethyldimethoxysilane, γ-glycidoxy-propyldimethylethoxysilane, hydrolyzates thereof, oligomers and mixtures thereof.

In certain embodiments, the precursor comprises a solid. In certain embodiments, the solid precursor comprises an oxide, a carbide, a polymer, such as polypropylene, and/or a metal, such as magnesium. Suitable solid precursors that may be used as part of the precursor stream include solid silica powder (such as silica fume, fumed silica, silica sand, and/or precipitated silica), cerium acetate, cerium oxide, boron carbide, silicon carbide, titanium dioxide, magnesium oxide, tin oxide, zinc oxide, aluminum oxide, bismuth oxide, tungsten oxide, molybdenum oxide, and other oxides, among other materials, including mixtures thereof. In certain embodiments, the precursor is not a solid silica powder.

In accordance with certain methods of the present invention, the precursor is contacted with a carrier. The carrier may be a gas that acts to suspend the precursor, such as a solid precursor in the gas, thereby producing a gas-stream suspension of the solid precursor. Suitable carrier gases include, but are not limited to, argon, helium, nitrogen, oxygen, air, hydrogen, or a combination thereof. In accordance with certain methods of the present invention, the precursor is heated by means of a plasma as the precursor flows through the plasma chamber, yielding a gaseous product stream. In certain embodiments, the precursor is heated to a temperature ranging from 2,500° to 20,000° C., such as 1,700° to 8,000° C.

In certain embodiments, the gaseous product stream may be contacted with a reactant, such as a hydrogen-containing material, that may be injected into the plasma chamber. The particular material used as the reactant is not limited, so long as it reacts with the precursor to produce the desired end product. Suitable reactant materials include, but are not limited to, air, water vapor, hydrogen gas, ammonia, and/or hydrocarbons.

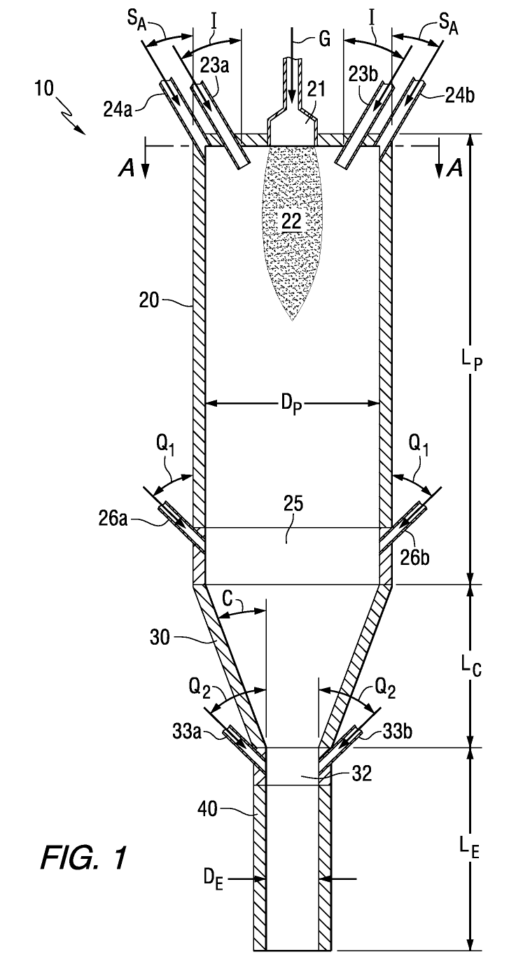

FIG. 1 illustrates a plasma system 10 in accordance with an embodiment of the present invention. The plasma system 10 includes a plasma chamber 20, a converging member 30, and an exit section 40. In the embodiment shown, the plasma chamber 20 is generally cylindrical, the converging member 30 is generally conical, and the exit section 40 is generally cylindrical. A plasma generator 21 located at a proximal or inlet end of the plasma chamber 20 generates a plasma 22 inside the chamber 20. A plasma gas G is fed to the plasma generator 21. Precursor materials are introduced into the plasma chamber 20 through precursor feed lines 23a and 23b. A carrier gas is used to mix with precursor materials and transport precursor materials into the plasma chamber. The carrier gas also provides a velocity for the stream to penetrate plasma plumb boundary into plasma hot zones.

In accordance with an embodiment of the present invention, sheath gas feed lines 24a and 24b are used to feed a sheath gas into the plasma chamber 20, as more fully described below.

A quench jet 25 is located at the distal end of the plasma chamber 20 upstream from the converging member 30. The quench jet 25 includes quench gas feed lines 26a and 26b through which a quench gas is introduced into the plasma chamber 20.

Another quench jet 32 is located at the distal end of the converging member 30 upstream from the exit section 40. The quench jet 32 includes quench gas feed lines 33a and 33b.

As shown in FIG. 1, the precursor feed lines 23a and 23b are oriented at precursor injection angles I measured from the axial flow direction of the chamber 20. The precursor injection angles I may typically range from 10 to 90 degrees, for example, from 30 to 70 degrees. The precursor injection angle I for each precursor feed line 23a and 23b may be the same angle, as shown in FIG. 1, or may be different angles. In one embodiment, the precursor feed lines 23a and 23b oppose each other around the circumference of the plasma chamber 20 in order to direct the flow of precursor materials at an angle toward each other as they enter the plasma chamber 20 and contact the plasma 22. Although two opposed precursor feed lines 23a and 23b are shown in the embodiment of FIG. 1, any other suitable number of feed lines may be used. For example, one, three, four, or more feed lines may be provided. The precursor(s) may be injected under pressure (such as greater than 1 to 100 atmospheres) through a small orifice at the end of each feed line 23a and 23b to achieve sufficient velocity to penetrate and mix with the plasma 22.

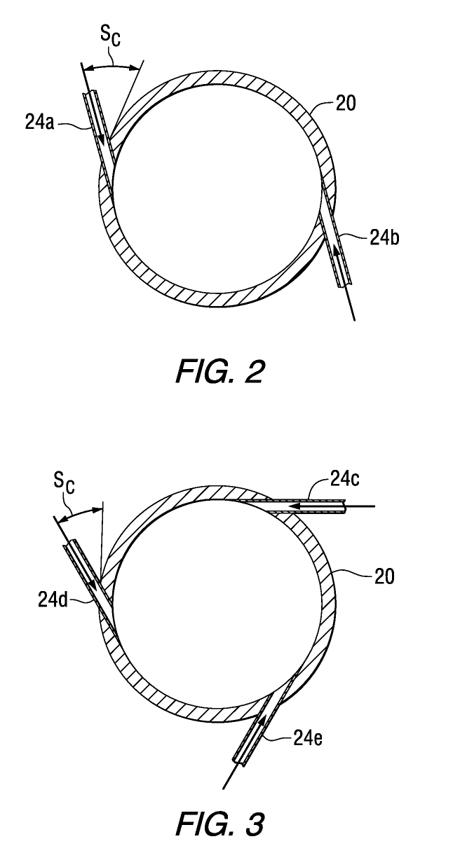

As shown in FIGS. 1 and 2, the sheath gas feed lines 24a and 24b are oriented at an axial sheath gas injection angle S_{A}, and at a circumferential sheath gas injection angle S_{C}. The axial sheath gas injection angle S_{A} shown in FIG. 1 may typically be from 10 to 90 degrees, for example, from 20 to 80 degrees, or from 30 to 60 degrees. The axial sheath gas injection angle S_{A} for each sheath gas feed line 24a and 24b may be the same, as shown in FIG. 1, or may be different. The circumferential sheath gas injection angle S_{C} shown in FIG. 2 may typically be from 10 to 90 degrees, for example, from 20 to 80 degrees, or from 30 to 60 degrees. The circumferential sheath gas injection angle S_{C} for each sheath gas feed line 24a and 24b may be the same, as shown in FIG. 1, or may be different. In the embodiment shown in FIGS. 1 and 2, two sheath gas feed lines 24a and 24b are provided. However, any other suitable number of sheath gas feed lines may be used, e.g., one, three, four, or more. FIG. 3 illustrates an alternative embodiment in which three sheath gas feed lines 24c, 24d, and 24e are used.

As shown in FIG. 1, the quench gas feed lines 26a and 26b are oriented at an angle Q₁ measured from the axial flow direction of the plasma chamber 20. The quench injection angle Q₁ may typically range from 10 to 90 degrees, for example, from 20 to 80 degrees, or from 30 to 60 degrees. The quench gas feed lines 33a and 33b are oriented at a quench gas injection angle Q₂ measured from the axial flow direction of the plasma chamber 20. The quench gas injection angle Q₂ may typically range from 10 to 90 degrees, for example, from 20 to 80 degrees, or from 30 to 60 degrees. While the quench ring 25 includes two quench gas feed lines 26a and 26b, and the quench ring 32 also includes two quench gas feed lines 33a and 33b in the embodiment shown in FIG. 1, it is to be understood that any suitable number of quench gas feed lines may be used in each quench ring. For example, one, three, four, or more quench feed lines may be utilized.

As shown in FIG. 1, the plasma chamber 20 has an axial length L_{P} and an inner diameter D. The length L_{P} of the plasma chamber 20 may typically range from 0.1 to 5 meters, for example, from 0.2 to 2 meters. The diameter D_{P} of the plasma chamber 20 may typically range from 0.02 to 2 meters, for example, from 0.03 to 0.6 meters.

The converging member 30 has an axial length L_{C} and a constriction angle C. The length L_{C} of the converging member may typically range from 0.2 to 5 meters, for example, from 0.2 to 1 meter. The constriction angle C of the converging member 30 may typically range from 1 to 89 degrees, for example, from 14 to 23 degrees.

The exit section 40 has an axial length L_{E} and an inner diameter D_{E}. The ratio of the length L_{E} to the inner diameter D_{E} of the exit section 40 may typically range from 1:1 to 100:1, for example, from 2:1 to 15:1.

The diameters of the plasma chamber 20 and exit section 40 have a ratio D_{P}:D_{E} that may typically range from 2:1 to 7:1, for example, from 2.6:1 to 6.2:1.

The length L_{P} of the plasma chamber 20 and the length L_{E} of the exit section 40 have a ratio L_{P}:L_{E} that may typically range from 1:1 to 3:1, for example, from 1.3:1 to 2.8:1.

The plasma chamber 20 may be constructed of water cooled stainless steel, nickel, titanium, copper, aluminum, or other suitable materials. The plasma chamber 20 can also be constructed of ceramic materials to withstand a vigorous chemical and thermal environment. For example, the plasma chamber may be lined with a ceramic such as alumina, alumina silicate, graphite, yttria stabilized zirconia, etc. The plasma chamber walls may be internally heated by a combination of radiation, convection and conduction. In certain embodiments, cooling of the plasma chamber walls prevents unwanted melting and/or corrosion at their surfaces. The system used to control such cooling should maintain the walls at as high a temperature as can be permitted by the selected wall material, which often is inert to the materials within the plasma chamber at the expected wall temperatures.

The inside diameter of the plasma chamber 20 may be determined by the fluid properties of the plasma and moving gaseous stream. In certain embodiments, the inside diameter of the plasma chamber is sufficiently great to permit necessary gaseous flow, but not so large that recirculating eddies or stagnant zones are formed along the walls of the chamber. Such detrimental flow patterns can cool the gases prematurely and precipitate unwanted products. In many cases, the inside diameter of the plasma chamber 20 is more than 100% of the plasma diameter at the inlet end of the plasma chamber.

In accordance with an embodiment of the present invention, after the gaseous product stream is produced in the plasma chamber 20, it is passed through the converging member 30. The stream may be contacted with quench streams before, during and/or after it passes through the converging member 30 to cause production of ultrafine particles. While the converging member 30 may act to cool the product stream to some degree, the quench streams perform much of the cooling so that the ultrafine particles are primarily formed downstream of the converging member. As used herein, the term “converging member” refers to a device that includes at least a section or portion that progresses from a larger diameter to a smaller diameter in the direction of flow, thereby restricting passage of a flow therethrough, which can permit control of the residence time and the flow pattern in the plasma chamber due to a controlled pressure differential upstream and downstream of the converging member. In certain embodiments, the converging member 30 is a conical member, i.e., a member whose base is relatively circular and whose sides taper towards a point, whereas, in other embodiments, the converging member is a converging-diverging nozzle of the type described in U.S. Pat. No. RE37,853 at col. 9, line 65 to col. 11, line 32, the cited portion of which being incorporated by reference herein.

As the gaseous product stream is passed through the converging member 30, it may be contacted with a plurality of quench streams that are injected into the plasma chamber through a plurality of quench stream injection ports, wherein the quench streams are injected at flow rates and injection angles that result in impingement of the quench streams with each other within the gaseous product stream. The material used in the quench streams is not limited, so long as it adequately cools the gaseous product stream to cause formation of ultrafine particles. Materials suitable for use in the quench streams include, but are not limited to, hydrogen gas, carbon dioxide, air, nitrogen, argon, water vapor, ammonia, mono, di and polybasic alcohols, and/or hydrocarbons.

The particular flow rates and injection angles of the various quench streams may vary, so long as they impinge with each other within the gaseous product stream to result in the rapid cooling of the gaseous product stream to produce ultrafine particles. This differentiates the present invention from certain fast quench plasma systems that primarily or exclusively utilize Joule-Thompson adiabatic and isoentropic expansion through, for example, the use of a converging-diverging nozzle or a “virtual” converging-diverging nozzle, to form ultrafine particles. In the present invention, the gaseous product stream is contacted with the quench streams to produce ultrafine particles after passing those particles through a converging member, such as, for example, a converging-diverging nozzle, which the inventors have surprisingly discovered aids in reducing the fouling or clogging of the plasma chamber, thereby enabling the production of ultrafine particles from a solid precursor without frequent disruptions in the production process for cleaning of the plasma system. In the present invention, the quench streams primarily cool the gaseous product stream through dilution, rather than adiabatic expansion, thereby causing a rapid quenching of the gaseous product stream and the formation of ultrafine particles after passing the gaseous product stream into and through a converging member, such as a converging-diverging nozzle.

In the methods of the present invention, the converging member may act as a choke position that permits control of pressure and flow patterns in the reactor. The combination of quench stream dilution cooling with a converging member appears to provide a commercially viable method of producing ultrafine particles from solid precursors using a plasma system, since, for example, (i) a solid feed material can be used effectively without heating the feed material to a gaseous or liquid state before injection into the plasma, and (ii) fouling of the plasma system can be minimized or eliminated by controlling pressure and flow patterns in the reactor, thereby reducing or eliminating disruptions in the production process for cleaning of the system.

In certain embodiments of the present invention, one or more sheath streams are injected into the plasma chamber upstream of the converging member. As used herein, the term “sheath stream” refers to a stream of gas that is injected prior to the converging member and which is injected at flow rate(s) and injection angle(s) that result in a barrier separating the gaseous product stream from the plasma chamber walls, including the converging portion of the converging member. The material used in the sheath stream(s) is not limited, so long as the stream(s) act as a barrier between the gaseous product stream and the converging portion of the converging member, as illustrated by the prevention, to at least a significant degree, of material sticking to the interior surface of the plasma chamber walls, including the converging member. For example, materials suitable for use in the sheath stream(s) include, but are not limited to, those materials described earlier with respect to the quench streams.

By proper selection of the converging member 30 dimensions, the plasma system 10 can be operated at atmospheric pressure, or slightly less than atmospheric pressure, or, in some cases, at a pressurized condition, to achieve the desired uniform pressure levels, flow patterns, and residence time, while the exit section 40 downstream of the converging member 30 may optionally be maintained at a vacuum pressure by operation of a vacuum producing device, such as a vacuum pump (not shown).

In accordance with an embodiment of the present invention, a substantially constant pressure is maintained throughout the plasma chamber 20 and throughout the converging member 30 during operation of the plasma system 10. As used herein, the term “substantially constant pressure” means that there is not a significant pressure variance inside the plasma chamber 20 and converging member 30, for example, as measured along the central axis of the system. Furthermore, pressure variances within each of the plasma chamber 20 and converging member 30 may be minimized or eliminated, e.g., the pressure level at all axial and radial positions within each of the plasma chamber 20 and converging member 30 are substantially the same. In certain embodiments, the substantially constant pressure, e.g., as measured in psi, is maintained within 0.5 percent at all locations in the plasma chamber 20 and converging member 30, for example, within 0.4 percent or within 0.3 percent. For example, the pressure may be maintained within 0.2 or 0.1 percent. Such substantially constant pressures are achieved in accordance with the present invention by the combination of reactor design and controlling flowrates. For example, if the quench gas ports were oriented at 90 degrees to the reactor axis, the flow could cause a choking point resulting in local pressure non-uniformity in the upstream section of the reactor. However, when the quench gas ports are oriented at an angle to the reactor axis as provided herein, the reactor pressure is uniform at lower quench gas flow rates because no choking point is created.

Typical operating pressures within the plasma chamber 20 and converging member 30 are from 600 to 950 torr, for example, from 650 to 760 torr. In certain embodiments, the pressure within the plasma chamber 20 and converging member 30 is kept below 900 or 800 torr, for example below 700 torr, in order to avoid unwanted turbulence or backflow of gaseous material within the system.

In accordance with an embodiment of the present invention, the material flow pattern inside the plasma chamber 20 and converging member 30 is substantially uniform. As used herein, the term “substantially uniform material flow pattern” means that material in all regions of the plasma chamber 20 and converging member 30 has an axial flow component directed from the inlet end to the outlet end thereof, with minimal or no material flowing axially backward in any region of the plasma chamber 20 and converging member 30. Thus, there is minimal or no backflow of gases or any other liquid or solid material in the plasma chamber 20 and converging member 30. The substantially constant flow pattern is achieved in accordance with the present invention by the combination of reactor design and controlling flowrates. Such a substantially uniform material flow pattern has been found to prevent fouling of the plasma system and to produce improved efficiency and yields of ultrafine particles.

Following production of the ultrafine particles, they may then be cooled. In certain embodiments of the methods of the present invention, after the ultrafine particles are produced, they are collected. Any suitable means may be used to separate the ultrafine particles from the gas flow, such as, for example, a bag filter or cyclone separator.

The inventors have surprisingly discovered that the methods and apparatus of the present invention, which utilize quench stream dilution cooling in combination with a converging member, such as, in some cases, a converging-diverging nozzle of the type described earlier, has several benefits. First, such a combination allows for the use of sufficient residence times of the materials within the plasma system that make the use of solid precursors practical. Second, fouling of the plasma chamber can be minimized, particularly in those embodiments wherein at least one sheath stream is used as described earlier, since the amount of material sticking to the interior surface of the converging member is reduced or, in some cases, eliminated. Third, the combination used in the present invention allows for the collection of ultrafine particles at a single collection point, such as a filter bag, with a minimal amount of ultrafine particles being deposited within the cooling chamber or cooling section described earlier.

Illustrating the invention are the following examples that are not to be considered as limiting the invention to its details.

### Example 1

A computer simulation using commercially available Fluent software was run with a reactor design similar to that shown in FIG. 1 having a 5-foot long cylindrical section, 2.5-foot long conical section, and 3-foot long exit pipe. The diameters of the cylindrical section and the exit pipe are 24 inches ID and 6-inches ID, respectively. The computer simulation is based on several assumed parameters. Plasma air is fed axially through the plasma-gas inlet port which in turn passes through a DC-electric arc that penetrates into the reactor and causes heating. The penetrating arc is approximated to a cylindrical-conical projection into the reactor and modeled via imposing a volumetric energy source in that region. Silica particles carried by air are fed through the two solid feed inlet tubes located on either side of the plasma-gas inlet. Sheath air is fed through four sheath-gas inlets, sized ⅜-inch ID, situated on the cylindrical wall close to the top-plate. The model is created to allow for quench air to be fed in two stages at Port-1 and Port-2. Port #1 has twelve inlets, sized ⅜-inch ID, situated around the cylindrical chamber close to the upstream end of the conical section. Port #2 has six inlets, sized ¼-inch ID, situated around the wall of the water cooled pipe close to the downstream end of the conical section. All the constituents exit out through the exit pipe.

Air at 500 slpm (liter per minute at STP) and 300 K enters the reactor through the main plasma-gas inlet. The plasma arc zone is presumed a cylindrical-conical shaped volume in the model to represent the electric arc penetrating the reactor. A volumetric heat source corresponding to 300 kW is imposed in that region. Also, air at 190 slpm and 300 K is fed through the solid feed inlets. Silica particles are introduced through this inlet at a mass flow rate of 45 lb/hr carried by the air flowing into the reactor. Sheath gas (air) at 1000 slpm (total for all four sheath gas inlets) is introduced at 300 K. The gas jets enter the reactor swirling in a clockwise direction with respect to the reactor axis. The swirl is defined by two angles, one at 60° with reactor axis and the other at 30° with the tangent to the reactor circumference. At quench gas Port #1, no air is introduced. At quench gas Port #2, air at 1,550 slpm (total for all six inlets) is introduced at 300 K and maintained at 40° directed straight towards the reactor axis without any swirl.

The Fluent software model consists of about 800,000 cells for the reactor system. Most of these cells are hexahedral which results in a good quality mesh. In the computer modeling all gases are treated as ideal gas. The specific heat of the gases is assumed constant and is calculated using the “kinetic theory” option in Fluent. All other properties such as thermal conductivity and viscosity are allowed to depend on temperature and pressure and are calculated using the “kinetic theory” option in Fluent. Mixture properties are computed using appropriate mixture laws. Turbulence is modeled using the Realizable k-ε model.

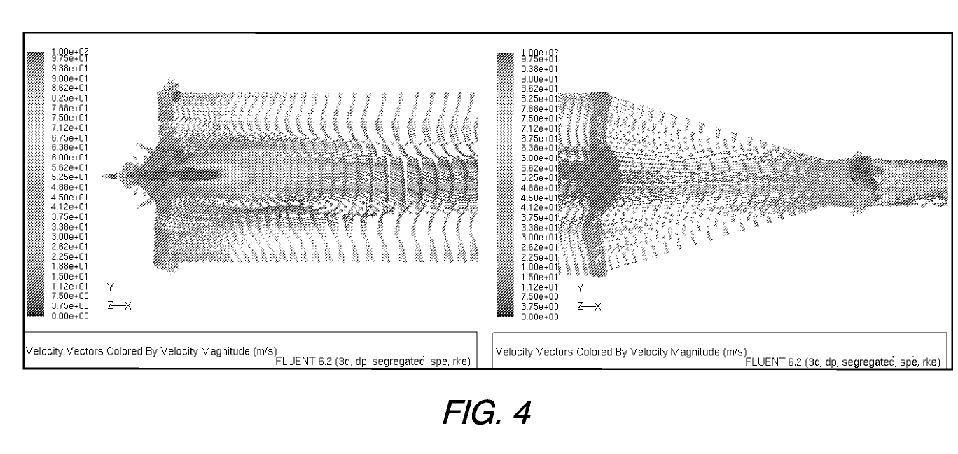

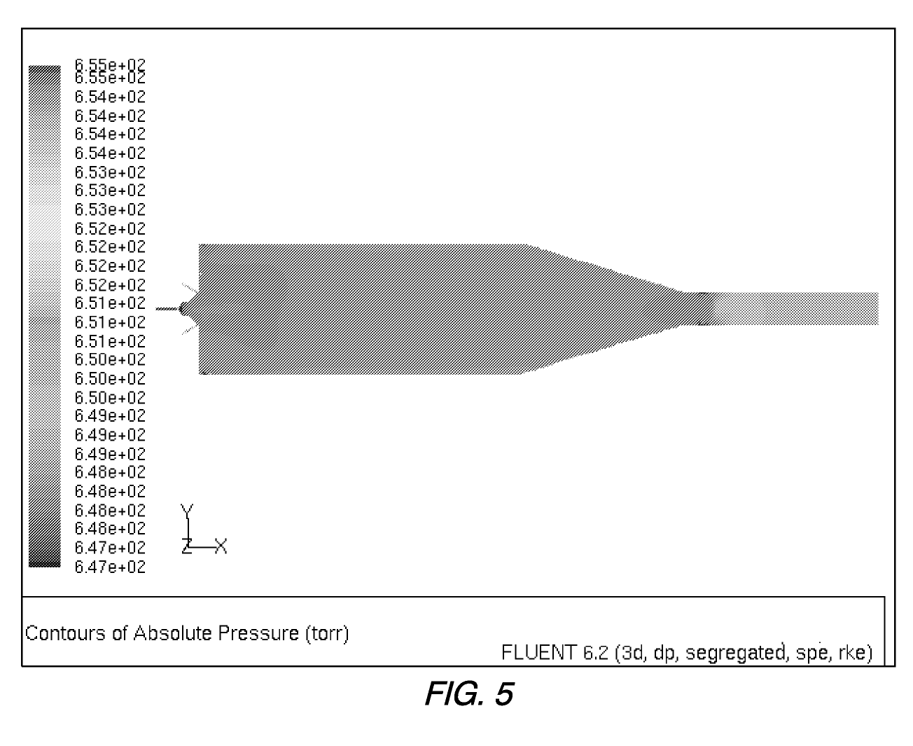

FIG. 4 illustrates velocity profiles resulting from the analysis. The velocity vectors are relatively uniform and unidirectionally distributed at the cylindrical section and conical section of the reactor indicating no recirculation zones. FIG. 5 illustrates a pressure profile resulting from the analysis. Pressure is nearly uniform in the interior of the reactor. Specifically, the pressures illustrated in FIG. 5 range from 648 to 650 torr, representing a 0.3 percent pressure difference. Slightly increased pressure in the exit pipe is due to high quench gas flowrate at Port #2. The average pressure in the reactor is 650 torr.

### Example 2

In a comparative computer simulation, the reactor has the same geometry of Example 1 except the cylindrical section of the reactor has a 16 inch ID. Air at 500 slpm (liter per minute at STP) and 300 K enters the reactor through the main plasma-gas inlet. The plasma arc zone is presumed a cylindrical-conical shaped volume in the model to represent the electric arc penetrating the reactor. A volumetric heat source corresponding to 300 kW is imposed in that region. Also, air at 190 slpm and 300 K is fed through the solid feed inlets. Silica particles are introduced through this inlet at a mass flow rate of 40 lb/hr carried by the air flowing into the reactor. Sheath gas (air) at 1,225 slpm (total for all four sheath gas inlets) is introduced at 300 K. The gas jets enter the reactor swirling in clockwise direction with respect to the reactor axis (x-axis). The swirl is defined by two angles, one at 60° with reactor axis and the other at 30° with the tangent to the reactor circumference. At quench gas Port #1, air at 1,200 slpm (total for all twelve inlets) is introduced at 300 K. Incoming air is maintained at 60° with reactor axis swirling in the opposite direction as that of sheath gas. At quench gas Port #2, air at 1,200 slpm (total for all six inlets) is introduced at 300 K and maintained at either 60° directed straight towards the reactor axis without any swirl.

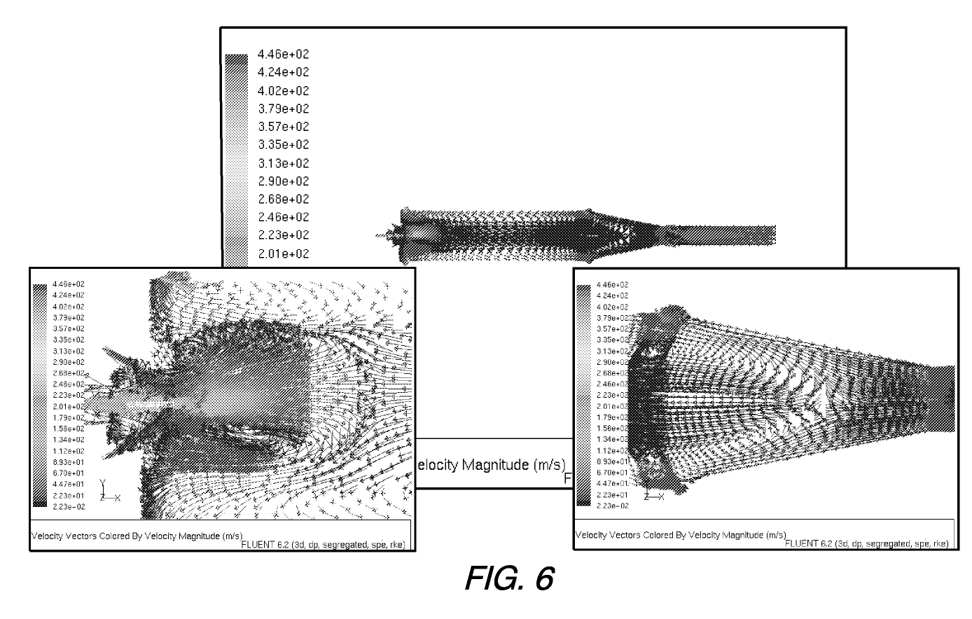

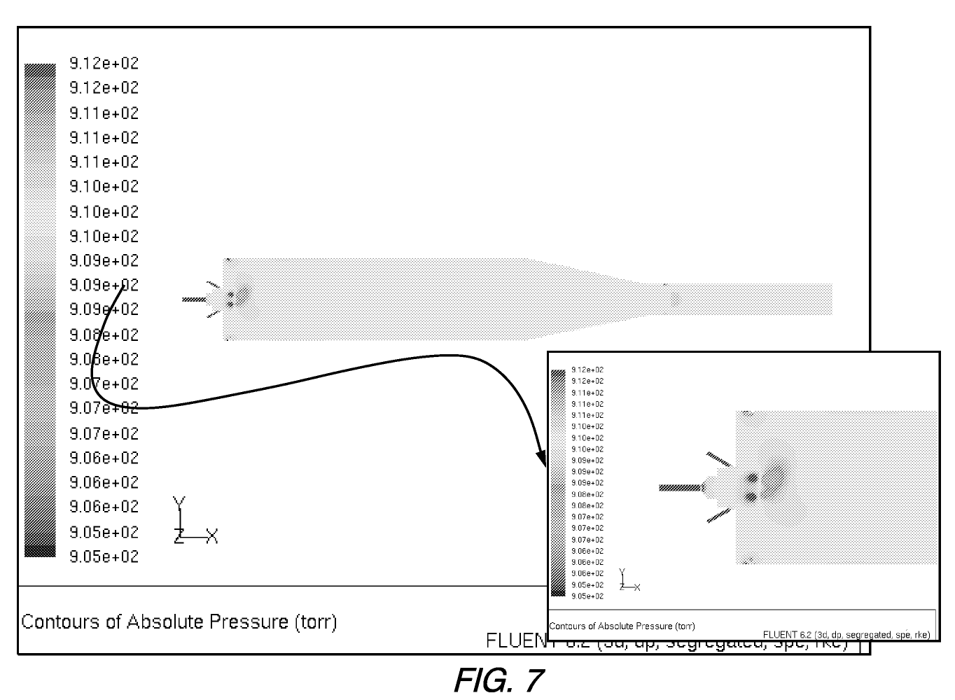

A comparative analysis of material flow patterns in a plasma chamber was conducted using the geometry and boundary conditions listed above. FIG. 6 illustrates velocity profiles resulting from the analysis. The velocity vectors indicate a turbulent flow pattern with several regions of unwanted backflow. FIG. 7 illustrates a pressure profile resulting from the comparative analysis. Pressure is not uniform, especially at the front end of the reactor. Pressures range from 907 to 912 torr, representing greater than a 0.5 percent pressure difference. The average pressure in the reactor is 910 torr.

### Example 3

A reactor was built with the geometry as described in Example 1. Air at 500 slpm was used as plasma gas in a DC plasma torch operated at 300 kW net input to the reactor. Total sheath gas (air) was 198 slpm. Carrier gas (air) at the feed tubes was 82 slpm. Total quench gas (air) at Port #2 was 1,132 slpm. The feed material is solid tungsten oxide powder (Global Tungsten & Powders Corp, Towanda, Pa.) with 16 μm average particle size. The feed rate was controlled at 40 lb/hr. The pressure in the reactor was maintained at 680 torr.

The measured B.E.T. specific surface area for the produced material was 32 square meters per gram using a Gemini model 2360 analyzer and the calculated equivalent spherical diameter was 26 nanometers.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A system for making ultrafine particles, comprising:
(a) a plasma chamber having axially spaced inlet and outlet ends;
(b) a high temperature plasma positioned adjacent the inlet end of the plasma chamber;
(c) at least one precursor inlet for introducing a precursor to the plasma chamber where the precursor is heated by the plasma to produce a gaseous product stream flowing toward the outlet end of the plasma chamber; and
(d) a converging member located adjacent the outlet end of the plasma chamber through which the gaseous product stream flows, wherein a substantially constant pressure is maintained in the plasma chamber and the converging member during operation of the apparatus.

2. The system of claim 1, wherein the pressure varies by less than 0.5 percent in the plasma chamber and the converging member.

3. The system of claim 1, wherein the pressure varies by 0.3 percent or less in the plasma chamber and the converging member.

4. The system of claim 1, wherein the pressure is less than 900 torr.

5. The system of claim 1, wherein the pressure is from 600 to 700 torr.

6. The system of claim 1, comprising a plurality of the precursor inlets, wherein the precursor inlets are located on radially opposite sides of the plasma chamber and direct the precursor into the plasma chamber at inlet angles of from 20 to 80 degrees measured from an axial direction of the plasma chamber.

7. The system of claim 1, further comprising at least one sheath stream inlet oriented at an axial injection angle of from 20 to 80 degrees measured from an axial direction of the plasma chamber, and at a circumferential injection angle of from 20 to 80 degrees measured from a tangential direction of the plasma chamber perpendicular to the axial direction.

8. The system of claim 1, further comprising a plurality of quench stream injection ports located in the plasma chamber upstream from the converging member oriented at an injection angle of from 20 to 80 degrees measured from an axial direction of the plasma chamber.

9. The system of claim 1, further comprising a plurality of quench stream injection ports located downstream of the plasma chamber at a reduced diameter section of the converging member, through which a plurality of quench streams are injected into the gaseous product stream.

10. The system of claim 9, wherein the quench stream injection ports are oriented at an injection angle of from 20 to 80 degrees measured from an axial direction of the plasma chamber.

11. The system of claim 1, wherein the plasma chamber has an axial length of from 0.2 to 1.6 meter, and the converging member has an axial length of from 0.2 to 1 meter.

12. The system of claim 1, wherein the converging member is generally conical and has a converging angle of from 10 to 30 degrees measured from an axial direction of the converging member.

13. The system of claim 12, wherein the converging member has an inlet opening diameter and an outlet opening diameter, and the ratio of the inlet opening and outlet opening diameters is from 2.2:1 to 6:1.

14. The system of claim 1, further comprising a generally cylindrical exit section located adjacent an outlet end of the converging member.

15. The system of claim 14, wherein the exit section has an inner diameter, the plasma chamber has an inner diameter, and the ratio of the plasma chamber inner diameter to the exit section inner diameter is from 2:1 to 7:1.

16. The system of claim 14, wherein the plasma chamber has an axial length, the exit section has an axial length, and the ratio of the plasma chamber axial length to the exit section axial length is from 1:1 to 3:1.

17. A system for making ultrafine particles, comprising:
(a) a plasma chamber having axially spaced inlet and outlet ends;
(b) a high temperature plasma positioned adjacent the inlet end of the plasma chamber;
(c) at least one precursor inlet for introducing a precursor to the plasma chamber where the precursor is heated by the plasma to produce a gaseous product stream flowing toward the outlet end of the plasma chamber; and
(d) a converging member located adjacent the outlet end of the plasma chamber through which the gaseous product stream flows, wherein a substantially uniform material flow pattern is maintained in the plasma chamber and the converging member during operation of the apparatus.

18. The system of claim 17, wherein the substantially uniform material flow pattern includes no axial backward flow of material in the plasma chamber and converging member.

19. The system of claim 17, wherein a substantially constant pressure is maintained in the plasma chamber and converging member during operation of the system.

20. A method of making ultrafine particles comprising:
introducing a precursor material into a plasma chamber;
heating the precursor material in the plasma chamber with a plasma to produce a gaseous product stream flowing toward an outlet end of the plasma chamber; and
passing the gaseous product stream through a converging member located adjacent the outlet end of the plasma chamber, wherein a substantially constant pressure and a substantially uniform material flow pattern are maintained in the plasma chamber and converging member as the gaseous product stream flows through the plasma chamber and converging member.
